(19) United States
(12) Patent Application Publication
(10) Pub. No.: US 2003/0101270 A1
(43) Pub. Date: May 29, 2003

(54) Simple and secure method for blocking data records from CGI scripts

(76) Inventor: Thomas Heptner, Muenchen (DE)

Correspondence Address: BELL, BOYD & LLOYD, LLC, P. O. BOX 1135, CHICAGO, IL, 60690-1135, US

(21) Appl. No.: 10/304,734

(22) Filed: Nov. 26, 2002

(30) Foreign Application Priority Data
Nov. 28, 2001 (DE) 101 58 396.6
Apr. 26, 2002 (DE) 102 18 829.7

(51) Int. Cl. G06F 15/16

(52) U.S. Cl. 709/229

(57) ABSTRACT

A data communication method, a computer device for use in a data communications system, and a data communications system are provided which have at least one central computer device, at least one memory device in which a large number of data elements are stored, a number of clients which can access the data elements, and a time data provision device which provides the computer time or data relevant to the client time, wherein each data element has an associated data field in which communication control data determined on the basis of the data relating to the computer or client time is entered which can indicate a blocking duration time or on the basis of which a blocking duration time can be determined, with respect to which, after an access, initiated from a first client, to a specific data element, this data element is enabled once again for an access initiated from a further client.

### BACKGROUND OF THE INVENTION

Data transmission via the Internet is becoming increasingly important. In this case, for example, a central computer (server computer) communicates with, for example, a client arranged remotely from it, such as a stationary or portable computer, or a mobile telephone, etc.

The communication process takes place using so-called Internet protocols; in particular, the Transmission Control Protocol (TCP) and the Internet Protocol (IP), or TCP/IP for short.

To do this, for example, (browser) software is loaded on the client, which software can understand and evaluate the TCP/IP protocol (socket or TCP/IP stack).

The fastest growing service on the Internet is based on the Hypertext Transfer Protocol (HTTP) and is called the World Wide Web (WWW). Individual documents, so-called web sites or web pages, can be transmitted via the World Wide Web.

HTTP is a client-server protocol. Before setting up an Internet link between the client and the server computer, the client can for certain applications, for example initially, be connected to a further web host, which is associated with it, of an Internet service provider (ISP). Server software which corresponds to the client software (that is to say, the browser) on the client runs on this Internet service provider (ISP).

The web address associated with the respectively desired web site on the server computer is then entered on the client, to which the ISP web host associated with that client then sets up an Internet link.

The web address is stated in the form of a URL address (URL=Universal Resource Locator) that is associated with the respective web site. This is formed from a number of parts. The first part denotes the Internet protocol (character string “http://”).

The next part of the URL address denotes the respective server computer on which the web site is stored (so-called domain name), and the subsequent part, if it exists, denotes the path to a local directory in which the web site is stored on the server computer. The last URL address part can then denote the exact file name of the web site, which is then transmitted from the server computer with the ISP web host connected in between via the Internet to the client.

Instead of accessing single files, programs which are stored in a corresponding directory (for example, “cgi-bin”) in the server computer also can, by way of example, be started via the Internet. Programs such as these may, for example, be CGI programs (CGI=Common Gateway Interface). The last part of the URL then denotes the respective program file (for example, “action.cgi”).

A CGI program makes it possible, for example, to interchange information (or, in general, for example to check and/or to modify any desired data stored, for example, on corresponding data media, such as on a hard disk) between the client and a databank which is stored on a memory device associated with the server computer.

Once the CGI program has started, it makes contact with the databank, and interrogates the appropriate data. This may be in a large number of different formats (for example, text, graphics, audio and video data, URLs, etc.).

The data is formatted as appropriate by the CGI program, for example being changed to the HTML format or to a DHTML format, or to any other desired HTML derivative (HTML=Hypertext Markup Language; DHTML=Dynamic Hypertext Markup Language), and is then transmitted via the Internet to the client, for example in the form of an HTML or DHTML web site.

The respective web site is then displayed on the client's screen by the browser.

In the prior art, the communication between different clients and the server computer, especially for concurrency control (that is to say, for coordination of conflicting accesses to one and the same item of data), when a specific client is logging on with the server computer is controlled by opening a so-called session, which is assigned a specific identifier (session ID).

Different sessions (for example, sessions initiated by different clients) are administered using so-called session data, which is stored in the memory device of the server computer and is updated by a session administration or session management tool in the server computer.

If, for example, a specific client initiates a writing process to data stored in the abovementioned databank (or to any other data), this data is blocked (locked) for other clients by an appropriate annotation in the session data (to be more precise, for other sessions with a different session ID).

After the end of the writing process, or after the respective client has logged out (that is to say, with the session being closed correctly), the data is released (unlocked) once again by the session administration or session management tool, once again by an appropriate annotation in the session data.

If the user of the respective client leaves the respective application before the respective writing process has ended, and without having carried out a correct logout process prior to this, the corresponding data remains blocked.

In order to prevent this data from remaining blocked for a considerable amount of time, the session administration or session management tool regularly checks the activities taking place in the various sessions. If no activity takes place over a predetermined time period in one specific session, that session is ended, and the appropriate data is released.

The communication control process known from the prior art is relatively complex. Furthermore, if a user leaves an application without logging out correctly, the access to certain data can be blocked for a relatively long time.

The present invention is directed toward providing a novel data communications system, a novel computer device for use in such a data communications system, and a novel data communication method.

### SUMMARY OF THE INVENTION

According to one embodiment idea of the present invention, a data communications system is provided, which has at least one central computer device, at least one memory device in which a large number of data elements are stored, a number of clients, from which the data elements can be accessed, and a time data provision device which provides the computer time or data relevant to the client time, in which each data element has an associated data field (for example, a LockID) in which communication control data determined on the basis of the data relating to the computer or client time is entered which can indicate a blocking duration time or on the basis of which a blocking duration time can be determined, with respect to which, after an access, initiated from a first client, to a specific data element, this data element is enabled once again for an access initiated from a further client.

In one particularly advantageous embodiment, the communication control data which is entered in the data field and/or the LockID are/is unique in the data communications system, in order to avoid any type of malfunction.

Note: In the present application, the term “data element” should be understood as meaning that, in addition to a separate data element, it also covers a data record (including a number of separate data elements) and any desired collection of data which is intended to be blocked as a unit against conflicting accesses.

In one particularly advantageous embodiment, for a read/write access initiated from the first client to the data element, a read access is first of all carried out to the data element, followed by a write access, with the write access being carried out only once the communication control data or the LockID has been checked for identity.

This allows concurrency control to be achieved in a relatively simple manner, so that there is no need for the relatively complex conventional session administration or session management tools.

Additional features and advantages of the present invention are described in, and will be apparent from, the following Detailed Description of the Invention and the Figures.

### BRIEF DESCRIPTION OF THE FIGURES

FIG. 1 shows a schematic illustration of a data communications system according to one exemplary embodiment of the present invention.

FIG. 2 shows a schematic illustration of the data communication sequence in the data communications system shown in FIG. 1, wherein a data element access is made without any errors.

FIG. 3 shows a schematic illustration of the logic sequence of a read and write access to a data element in the data communications system shown in FIG. 1, and shows special cases or fault cases which can occur during access to a data element with the data communication method described here.

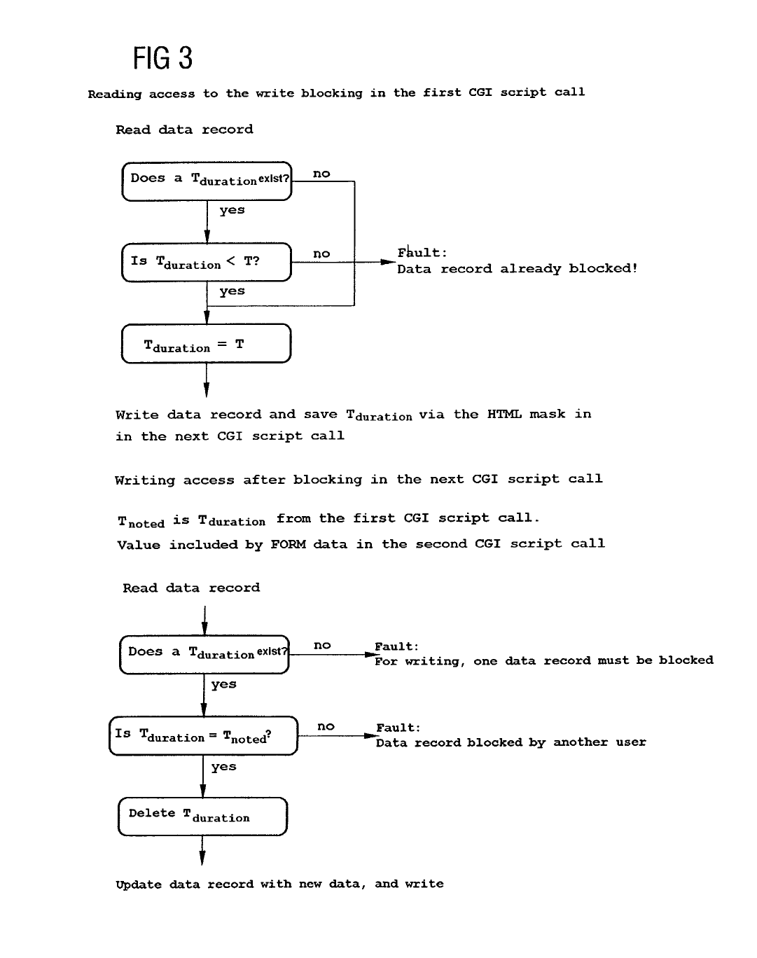

FIG. 4 shows a schematic illustration of the sequence and of the configuration of a method for allocating unique LockIDs in the data communications system shown in FIG. 1, or in a computer network having a number of central computers.

### DETAILED DESCRIPTION OF THE INVENTION

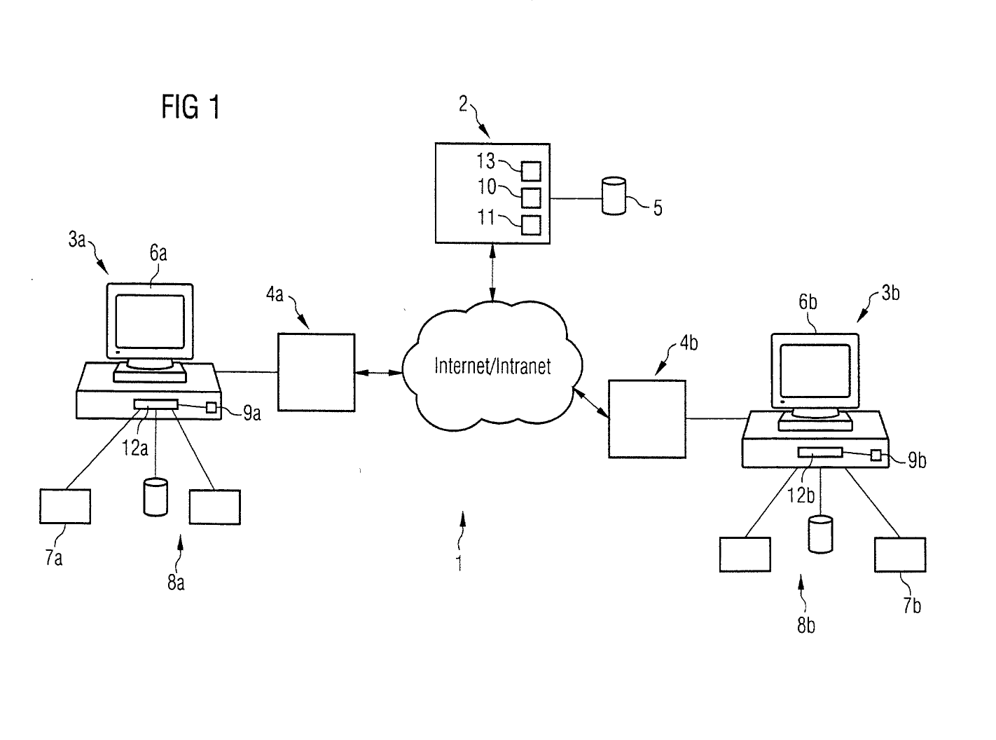

FIG. 1 shows a schematic illustration of a data communications system 1 according to one exemplary embodiment of the present invention.

The data communications system 1 has a central computer 2 (server computer), which is connected to the Internet (or alternatively to an Intranet).

In one alternative exemplary embodiment, which is not shown here, a number of central and/or local computers are used instead of the single central computer 2, and together carry out the same functionality as the central computer 2.

A first client 3a may be connected via a computer 4a of an ISP (ISP=Internet Service Provider), or directly via a tie line in one alternative exemplary embodiment, to the Internet.

A second client 3b (as well as a large number of other clients) is connected in a corresponding way via a further ISP computer 4b (or alternatively via the abovementioned ISP computer 4a or via further ISP computers which are not illustrated), or alternatively directly, to the Internet.

The clients 3a, 3b may, for example, be stationary or portable computers (for example, PCs, laptops or PDAs (PDA=Personal Digital Assistant)) or, for example, telephones, in particular mobile telephones.

The central computer 2 has one or more memory devices 5 (and/or is connected to one or more external memory devices). The memory device 5 may, for example, be a magnetic or optical memory, for example one or more hard disks on which appropriate data is stored, such as one or more program files and other user data which can be accessed by the clients 3a, 3b. The other user data may be in a large number of different formats (for example text, graphics, audio and video data, etc.).

The data may, for example, be stored in the form of structured files, which each have a large number of data elements (so-called data records). The storage can be carried out, for example, using one or more databanks, or in any other desired manner.

The central computer 2 contains one or more microprocessor devices 10, which is or are connected to one or more further memory devices 11. In principle, the memory device 11 may be any desired electrical, magnetic or optical memory; in particular, a main memory device for the microprocessor device 10.

Furthermore, the central computer 2 has a timing device 13; for example, a clock. This counts the time T which has passed since a predetermined reference time; for example, the seconds which have passed since Jan. 1, 1970.

As is also shown in FIG. 1, each client 3a, 3b has an output device 6a, 6b, such as a screen or a display, as well as an input device 7a, 7b, such as a mouse and/or a keyboard.

Furthermore, each client 3a, 3b has one or more memory devices 8a, 8b; for example, a hard disk, a CD-ROM drive and/or a floppy disk drive, etc.

Each client 3a, 3b contains one or more microprocessor devices 12a, 12b which is or are connected to one or more further memory devices 9a, 9b (for example, a microprocessor main memory device).

The central computer 2, or a program file stored in its memory device 5, has a specified associated URL address, which is formed from a number of parts.

The first part denotes the Internet Protocol (character string “http:”). This is followed by a separating character, which identifies the fact that it is followed by a server name (character string “//”).

The next part of the URL address identifies the central computer on which the program file is stored (so-called domain name (for example “www.heptner.com”)), and the subsequent part identifies the path to a local directory in which the abovementioned program file (and, optionally, further program files) is stored on the central computer (for example “cgi-bin”). The last URL address part identifies the name of the respective program file (for example “action.cgi”).

The program file may, for example, contain a CGI program (CGI=Common Gateway Interface). The CGI program makes it possible, for example, to interchange data between the respective client 3a, 3b and the databank which is stored in the memory device 5 of the central computer 2.

In order to start the CGI program, the appropriate URL address may be entered, for example, on the input device 7a, 7b of the respective client 3a, 3b. As a reaction to this, if this has not already been done before, an Internet link is set up in a manner which is known per se between the respective client 3a, 3b and the central computer 2, with the ISP computer 4a, 4b connected between them.

The CGI program which is stored in the abovementioned program file is then started.

Once the CGI program has started, it makes contact with the databank.

Two embodiments of the present invention are described in the following text, in which the mechanism of the “uniqueness” of a so-called LockID for each data element to be blocked is released in a different way in the data communications system 1.

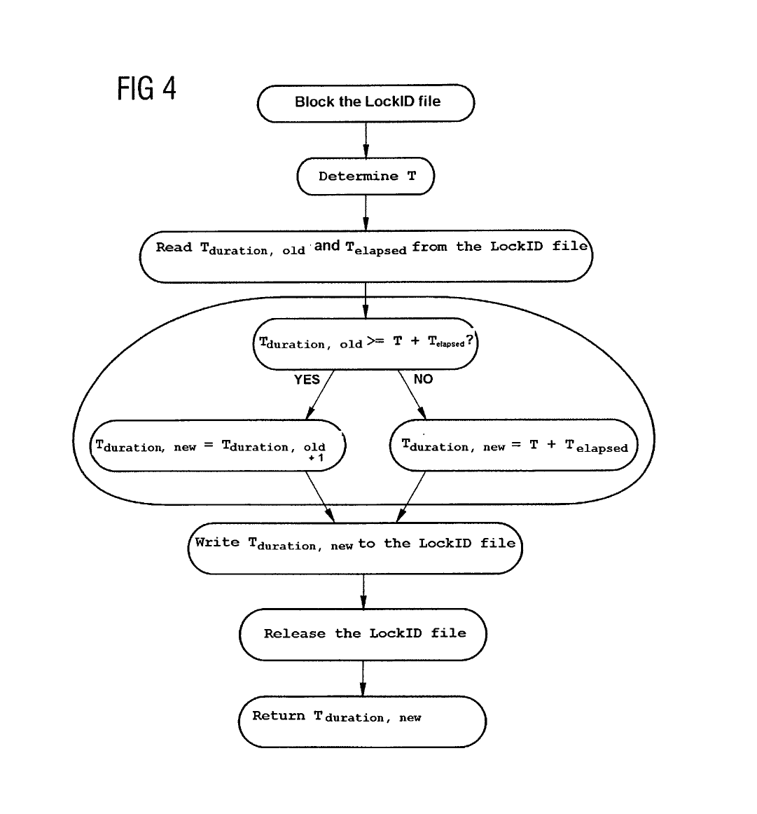

In a first advantageous embodiment, the LockID includes only one element, to be precise a blocking duration time (T_{duration}), which is produced via a central LockID allocation mechanism in the data communications system 1 (or in a computer network having a number of central computers whose function and design correspond to the central computer 2) as shown in FIG. 4.

The preconditions for the allocation mechanism are that the most recently used LockID (T_{duration, old}) and an elapsed time period T_{elapsed} are stored in the LockID file, and that the file is protected against concurrent access by a FileLock mechanism.

The following notes i)-iv) also apply to the allocation mechanism itself:

i) The higher the resolution of T, the lower is the probability that: T_{duration, old}>=T+T_{elapsed}, and the less is the addition effect for T_{duration, new} (T_{duration, new}>>T+T_{elapsed} or T_{duration, new}>>T_{duration, old}); that is to say, the resultant delay for a repeated access by another user (T_{duration, new}−T +T_{elapsed}).

ii) The storage of T_{elapsed} in the LockID file makes it possible for T_{elapsed} to be transferred throughout the system without any impediment. The transfer process takes place with T_{elapsed} being reduced by a delay which corresponds at most to the difference between T_{elapsed, old} and T_{elapsed, new}.

iii) The storage of T_{elapsed, old} instead of T (directly) allows T_{elapsed,} since it is independent of T, to be changed at any time while the uniqueness of the LockIDs nevertheless remains ensured since T_{elapsed, old} does not contain any reference to T, even when T_{elapsed} changes.

iv) As an alternative to what has been described above and the allocation mechanism illustrated in FIG. 4, it is also possible to use a counter which increments in the event of a request for a LockID relating to the same time T, and is reset when a new T occurs. This avoids the possibility of the delay described above.

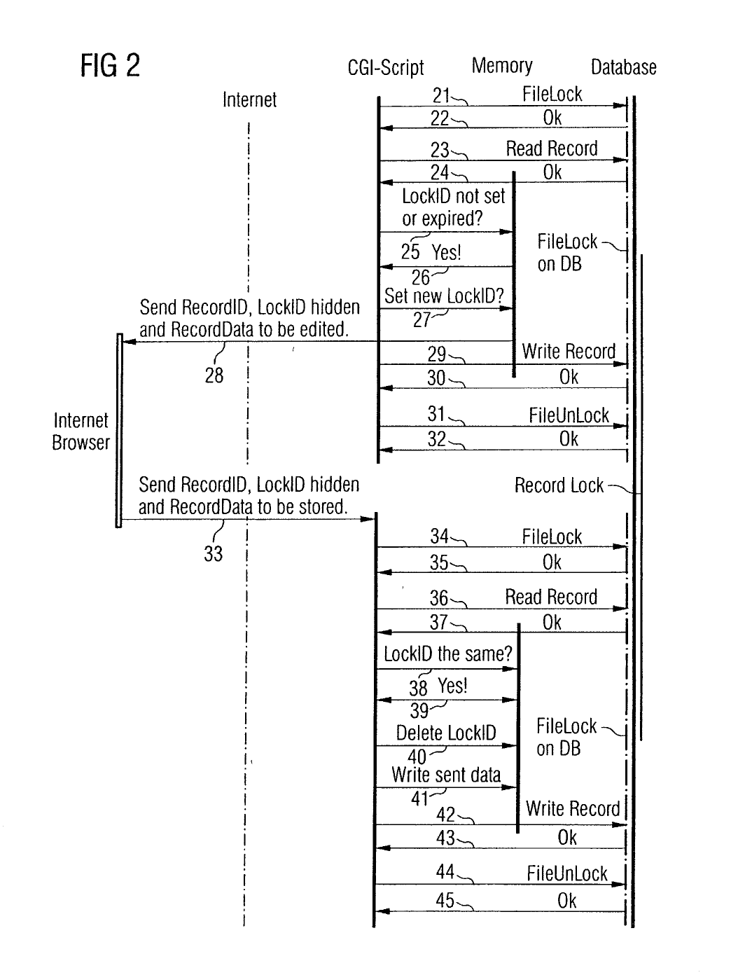

As is shown in FIG. 2, possibly after one of the abovementioned allocation methods has been carried out, the CGI program uses an appropriate command signal 21 (in this case: FileLock) to block the respectively affected file in the databank (database).

The FileLock command signal 21 may for this purpose contain an identifier which identifies the corresponding file (that is to say, an identifier for that file which contains the data element or the data record which is intended to be accessed).

In the event of an access to a number of data elements which may be contained in a number of different files, this command signal and all further command signals are called at least once with at least one parameter (the lock actions are successful only when the lock is possible for all the files and/or data elements in each case) and all the relevant files are blocked with the aid of the FileLock command signal 21 (the command signal 21 then contains the identifiers of all the files which contain data elements which are intended to be accessed).

When locking a number of data elements, it is sufficient to produce one T_{elapsed} time for all the data elements involved, and this is then stored in each of the associated LockID data fields. When locking a number of data elements, only one LockID then need be sent via the Internet, in a corresponding manner. This procedure, like all the other processes, is also described in the following text with reference to the process for locking one data element.

As is also shown in FIG. 2, and is also explained in more detail further below, the appropriate file (or the appropriate files) remains (or remain) blocked (blocked state of the file or files) (FileLock on Database)), until the corresponding file (or the corresponding files) is (or are) released once again by the CGI program via a command signal 31 (FileUnLock).

Once the file has been blocked (or the files have been blocked) the databank sends an appropriate acknowledgement message or a report signal 22 (OK) to the CGI program.

The CGI program then uses a further command signal 23 (in this case: Read Record) to read the relevant data element or elements from the databank. The Read Record command signal 23 contains one identifier (or a number of identifiers) (RecordID) which identifies (or identify) the corresponding data element (or elements) or record (or records).

The corresponding data element or elements is or are then transferred to the CGI program via an appropriate message signal 24 (OK).

For concurrency control (that is to say, in order to coordinate conflicting accesses to one and the same item of data), the CGI program uses, in addition to the abovementioned RecordID, communication control data associated with the RecordID or with the respective data element, or a LockID, which is entered in a data field, which is associated with the respective data element, in the respective data record.

The LockID contains a time stamp or a blocking duration time identifier T_{duration}, which, in accordance with the description in the following text, indicates the time until which the respective data record or the respective data element is intended to remain blocked (blocked state of the respective data record (Record Lock)).

As is also shown in FIG. 2, once the CGI program has completed the steps described above, it uses a command signal 25 (LockID not set or expired) to ask the state of the LockID associated with the respective data record or data element.

(Alternatively, the state of all the LockIDs associated with these data elements is checked in a corresponding manner when simultaneous access is made to a number of data elements.)

In particular, a check is carried out to determine whether the respective LockID indicates that the corresponding data element in the corresponding data record is no longer blocked because the blocking duration time T_{duration} has elapsed.

This is done by comparing the blocking duration time T_{duration} as indicated by the communication control data or the LockID with the current time T as measured by the timing device 13. If T_{duration}<T, the corresponding data record or the corresponding data element is released (once again), otherwise it is (still) blocked.

An appropriate message signal 26 (Yes!) is used to inform the CGI program if the LockID indicates that the corresponding data record or the corresponding data element is no longer blocked.

Otherwise (that is to say, if the LockID indicates that the corresponding data record or the corresponding data element is still blocked), the abovementioned message signal 26 contains an error message (No!).

(Alternatively, the message signal 26 contains an appropriate error message (No!) when simultaneous access occurs to a number of data elements or data records and if a single one of the number of LockIDs which are associated with those data elements or data records indicates that the corresponding data record is still blocked.)

An error message (which is formatted appropriately by the CGI program, that is to say it is changed to the HTML format or to an HTML derivative format) is then transmitted via the Internet to the respective client 3a, 3b, where it is output or displayed on the respective client output device 6a, 6b under the control of a browser software program which is stored in the, or in one of the, memory devices 8a, 8b of the respective client 3a, 3b (for example, the error message: “Access not possible at the moment!“).

Next, the CGI program uses a command signal corresponding to the command signal 31 which already has been mentioned above (in this case: FileUnLock) to release the relevant file or files on the databank once again. The FileUnLock command signal may for this purpose contain an identifier to identify the corresponding file (or identifiers to identify the corresponding files).

The release of the file (or of the files) is acknowledged via a signal which corresponds to the OK signal 32.

If, as explained above, the CGI program is informed by the message signal 26 (Yes!) that the respectively related LockID or the respectively related LockIDs indicates or indicate that the corresponding data record or the corresponding data records is or are not (no longer) blocked, the CGI program outputs a command signal 27 (Set new LockID), as shown in FIG. 2.

This command signal 27 causes the LockID or LockIDs which is or are stored in the abovementioned memory device 11 (memory) and is or are affected by the respective access (or by the respective accesses) to be updated.

The current time T, incremented by a predetermined elapsed time period T_{elapsed} and read from the timing device 13, is entered in the respective LockID as the (new) time stamp or the (new) blocking duration time identifier T_{duration, new} (that is to say, T_{duration, new}=T+T_{elapsed}).

The elapsed time period T_{elapsed} may, for example, be between 5 and 30 minutes, in particular between 10 and 20 minutes (for example, 15 minutes), and shall be chosen such that the respective user of a client 3a, 3b can end his/her inputs in a convenient manner.

The described mechanism also, however, allows a longer processing time for the data element by the respective user, to be precise when no other user wishes to make a write access to that data element in the meantime.

From the time at which the respective LockID was updated, the associated data element or the data record is blocked (blocked state of the data element or data record (Record Lock)).

The data element or the data record remains blocked until it is released again by the CGI program via a command signal 40 (Delete LockID) or until the blocking duration time indicated by the LockID, in particular by the blocking duration time identifier T_{duration}, has elapsed (that is to say, when T_{duration}<T, see above).

Next, a signal 28 (Send RecordID, LockID hidden and RecordData to be edited) is used to transmit the LockID (or the LockIDs), the data element or elements read from the databank and the RecordID or RecordIDs which identifies or identify the data element or elements via the Internet to the respective client 3a, 3b.

This data is formatted in advance in an appropriate manner by the CGI program; for example, being changed to the HTML format or to an HTML derivative format.

The LockID and the identifier or RecordID which identifies the data element or the data record are in each case sent such that, although they are stored in the corresponding memory device 8a, 8b, 9a, 9b of the respective client 3a, 3b, they are not output or displayed by the respective browser software program on the respective client output device 6a, 6b (so-called hidden transmission).

In contrast, the data element or elements or the data record or data records is or are sent “open”; that is to say, such that the data element or elements is or are output or displayed on the output device 6a, 6b of the respective client 3a, 3b under the control of the browser software program.

As is also shown in FIG. 2, the CGI program then uses a further command signal 29 (in this case: Write Record) to write the respective data element or the respective record to the databank once again. The Write Record command signal 29 contains the identifier or RecordID which identifies the corresponding data element or data record.

The databank then sends an appropriate acknowledgement message or message signal 30 (OK) to the CGI program.

Next, the CGI program uses the command signal 31 which already has been mentioned above (in this case: FileUnLock) to once again release the respectively related file or files on the databank (database). The FileUnLock command signal 31 may contain an identifier which identifies the corresponding file (or a number of identifiers which identify the corresponding files).

The release of the file or files is then acknowledged via the OK signal 32, which already has been mentioned above.

The respective data element or data record which is output or displayed as mentioned above on the output device 6a, 6b of the respective client 3a, 3b by the browser software program can be edited or modified by the respective user of the client 3a, 3b via appropriate inputs made on the input device 7a, 7b.

Next, a signal 33 (Send RecordID, LockID hidden and RecordData to be stored) is used to transmit the respective (possibly edited or modified) data element or data record, as well as the respectively associated LockID and the associated identifier or RecordID, which identifies the data element or the data record, back via the Internet to the central computer 2.

The received data is transmitted to the abovementioned CGI program or, alternatively, to a CGI program which differs from it (the appropriate CGI program is started (possibly newly) in advance).

Then, as shown in FIG. 2, the CGI program uses a command signal 34 (in this case: FileLock) to block the file associated with the corresponding data element or data record (or possibly a number of different files when accessing a number of different data elements).

The FileLock command signal 34 contains an identifier which identifies the corresponding file. When accessing a number of data elements which are contained in a number of different files, all the relevant files are alternatively blocked via the FileLock command signal 34 (the command signal 34 then contains the identifiers of all the files which contain data elements which are intended to be accessed).

The corresponding file or files remains or remain blocked (blocked file state (FileLock on Database)), until the corresponding file or files is or are released once again by the CGI program using a command signal 44 (FileUnLock).

When the file or files has or have been blocked, the databank sends an appropriate acknowledgement message or message signal 35 (OK) to the CGI program.

The CGI program then uses a further command signal 36 (in this case: Read Record) to read the respectively related data element or elements from the databank. The Read Record command signal 36 contains an identifier (or a number of identifiers) (RecordID) which identifies (or identify) the corresponding data element or elements or record or records.

The corresponding data element or elements is or are then transferred to the CGI program via an appropriate message signal 37 (OK).

As explained above, every (blocked) data record and every blocked data element contains a LockID (in this case: a time stamp or blocking duration time identifier T_{duration}).

As indicated in FIG. 2, after completing the steps mentioned above, the CGI program uses a command signal 38 (LockID the same?) to check the state of the LockID or LockIDs associated with the relevant data element or elements.

In particular, a check is carried out to determine whether the LockID or LockIDs transmitted by the corresponding client 3a, 3b using the abovementioned signal 33 is or are identical to the LockID of the respectively related data record or data element, or is or are identical to the LockIDs of the respectively related data records.

If yes, this ensures that the corresponding data element or the corresponding data record has not been accessed by another client, in a permissible manner, since the abovementioned access to the respective data element or data record by the client 3a, 3b (to be more precise: since the blocking of the corresponding data element by the abovementioned command signal 27 (Set new LockID)) (which would be possible if the data record blocking duration time T_{duration} had elapsed in the meantime). The CGI program is informed of this by an appropriate message signal 39 (Yes!).

Otherwise, that is to say, if the LockID transmitted by the corresponding client 3a, 3b is not identical to the LockID stored in the central computer 2a (the corresponding part of the data record or data element read by the command signal 36), the abovementioned message signal 39 contains an error message (No!).

Alternatively, the message signal 39 contains an appropriate error message (No!) in the event of simultaneous access to a number of data elements or data records if no identity is found for a single one of the number of LockIDs associated with the data elements or data records.

The CGI program then uses a command signal which corresponds to the command signal 44 (in this case: FileUnLock) to once again release the respectively related file or files on the databank (database). The release of the file or files is acknowledged via a signal which corresponds to the OK signal 45.

Furthermore, an error message (which is appropriately reformatted by the CGI program, for example being changed to the HTML format or to an HTML derivative format) is transmitted via the Internet to the respective client 3a, 3b, where it is output or displayed on the respective client output device 6a, 6b under the control of the browser software program (for example, the error message: “Access not possible at the moment!”).

If, instead of this and as mentioned above, the CGI program has been informed via the message signal 39 (Yes!) that the LockID or LockIDs transmitted by the respective client 3a, 3b, to be more precise: its or their (respective) second communication control data element is identical to the LockID or LockIDs stored in the central computer 2a (that is to say the corresponding part or parts of the data element or data elements or data record or data records read using the command signal 36), the CGI program deletes the corresponding LockID or LockIDs via the command signal 40 (Delete LockID).

This command signal 40 is used to once again release the corresponding data element or elements, or data record or data records.

As is shown in FIG. 2, a command signal 41 (Write sent Data) is next used to read corresponding data received by the respective client 3a, 3b (for example the corresponding (possibly modified) data element or data record) to the memory device 11 (memory).

As is also shown in FIG. 2, the CGI program then uses a command signal 42 (in this case: Write Record) to write the abovementioned (possibly modified) data element or the (possibly modified) data record to the databank. The Write Record command signal 42 contains the identifier or RecordID which identifies the corresponding data element or data record.

Next, the databank sends an appropriate acknowledgement message or message signal 43 (OK) to the CGI program.

The CGI program then uses the command signal 44 which already has been mentioned above (in this case: FileUnLock) to once again release the respectively related file or files on the databank (database).

The release of the file or files is acknowledged by the OK signal 45.

In a further advantageous embodiment, the LockID contains not only a blocking duration time data field but also a further communication control data field, which counts the successful lock attempts to the data element or to the data record and thus ensures uniqueness in the described communications system per data element or data record even when the blocking duration time is possibly the same. Since this uniqueness is sufficient, there is no need for the central LockID allocation mechanism, which is illustrated in FIG. 4, in the data communications system 1 with this refinement.

In addition to the refinement described above with a central allocation mechanism for the LockIDs instead of transmitting only one LockID (with only one data element) for all the data elements involved, each complete LockID must then be transmitted with all the communication control data fields for each data record which is involved and for each data element which is involved via the Internet/Intranet, in order to make it possible to check for identity with each corresponding LockID that is stored in the databank in the event of a second call, the attempt to make a write access.

Concurrency control can be achieved in a relatively simple manner in the described data communications system, so that there is no need for the relatively complex, conventional session administration or session management software programs, and/or for the use of conventional, costly databank software programs.

Although the present invention has been described with reference to specific embodiments, those of skill in the art will recognize that changes may be made thereto without departing from the spirit and scope of the present invention as set forth in the hereafter appended claims.

1. A data communications system, comprising:
at least one central computer device;
at least one memory device in which a plurality of data elements are stored;
a plurality of clients which can access the data elements; and
a time data provision device which provides data relevant to one of computer time and client time;
wherein each data element has an associated data field in which communication control data determined based on the data relevant to the computer time and client time is entered which can indicate a blocking duration time or based on which a blocking duration time can be determined, with respect to which, after an access, initiated from a first client, to a specific data element, the data element is enabled once again for an access initiated from a further client.

2. A data communications system as claimed in claim 1, wherein, for a read/write access initiated from the first client to the data element, a read access is first of all carried out to the data element, followed by a write access, with the write access being carried out only once the communication control data has been checked.

3. A data communications system as claimed in claim 2, wherein the write access is carried out only once the communication control data has been checked for identity.

4. A data communications system as claimed in claim 1, wherein the communication control data which indicates the blocking duration time is determined by respectively increasing one of the computer time and the client time by a predetermined time period.

5. A data communications system as claimed in claim 4, wherein the predetermined time period is between 2 and 30 minutes.

6. A data communications system as claimed in claim 4, wherein the predetermined time period is between 5 and 20 minutes.

7. A data communications system as claimed in claim 4, wherein the predetermined time period is between 10 and 15 minutes.

8. A data communications system as claimed in claim 1, wherein the data elements are stored in structured form, with a plurality of data elements each being allocated to one file.

9. A data communications system as claimed in claim 8, wherein, before access to the data element, the corresponding file is blocked, and the data element is released again after the access.

10. A data communications system as claimed claim 1, wherein the central computer device and the clients communicate via the Internet.

11. A data communications system as claimed in claim 1, wherein the client is a computer.

12. A data communications system as claimed in claim 1, wherein the client is a telephone.

13. A data communications system as claimed in claim 1, wherein the access which is initiated from the first client to the data element is annotated in the communication control data with assistance from an access identifier which identifies the access to a data element, by one of allocating a new access identifier and modifying an already allocated access identifier.

14. A data communications system as claimed in claim 13, wherein, when an access to the data element is first of all initiated from the first client and then, once the data element has been released after the blocking duration time, from the further client, the access which is initiated from the further client is annotated in the communication control data with assistance from the access identifier.

15. A data communications system as claimed in claim 14, wherein the access which is initiated from the further client is annotated in the communication control data by one of allocating a new access identifier and modifying an already allocated access identifier.

16. A data communications system as claimed in claim 15, wherein the write access is carried out only when the access identifier is one of identical to the access identifier allocated for the read access and identical to the access identifier modified in this case.

17. A data communications system as claimed in claim 1, wherein the central computer device initiates the determination of the communication control data.

18. A data communications system as claimed in claim 1, wherein at least one of the clients is a computer which initiates the determination of the communication control data.

19. A data communication method, wherein a plurality of data elements can be accessed from a plurality of clients, the data elements being stored in a memory device which is associated with a central computer device, the method comprising the steps of:
providing data which relates to one of computer time and client time by a time data provision device;
providing each data element with an associated data field in which communication control data determined based on the data relating to one of the computer time and the client time is entered which can indicate a blocking duration time or based on which a blocking duration time can be determined; and
enabling, with respect to the blocking duration time, after an access, initiated from a first client, to a specific data element, the data element once again for an access initiated from a further client.
